(19) United States
(12) Patent Application Publication
(10) Pub. No.: US 2025/0271325 A1
(43) Pub. Date: Aug. 28, 2025

(54) IN-GROUND MEASURING AND COMMUNICATION DEVICE OF INFORMATION MEASURED BY MEANS OF A MEASURING INSTRUMENT

(71) Applicant: GRTGAZ, BOIS-COLOMBES (FR)

(72) Inventor: Ralph GRUAND, SAINTE-LUCE-SUR-LOIRE (FR)

(21) Appl. No.: 18/858,809

(22) PCT Filed: Apr. 21, 2023
(86) PCT No.: PCT/FR2023/000044

§ 371 Date: Oct. 22, 2024

(30) Foreign Application Priority Data
Apr. 22, 2022 (FR) FR2203757

(51) Int. Cl. G01M 5/00; G01L 1/24; G01M 11/08

(52) U.S. Cl. CPC G01M 5/0058; G01L 1/246; G01M 5/0091; G01M 11/085

(57) ABSTRACT

A wireless measuring and communication device of information is measured by means of an information measuring instrument relative to the pipe which can be buried and measured from the outside of this pipe, with the measuring instrument which can be buried, the device being configured so that it can be buried near the pipe when wired communication is not permitted and comprising an interrogator connected to the measuring instrument and configured to deliver the measured information, a wireless communication module, a control module of the interrogator and of the wireless communication module, configured to obtain the information measured delivered by the interrogator and to send it to the wireless communication module for transmission, an electric power supply source feeding the control module, the interrogator, and the wireless communication module.

### TECHNICAL FIELD

The present invention relates to property-measuring devices relating to buried pipes or not. More particularly, it relates to measurements taken by means of measuring instruments installed in the vicinity of pipes. For example, these measuring instruments can be strain gauges or temperature sensors, and preferably fibre Bragg gratings laid on pipes or in repair systems or on pipe repair systems.

### PRIOR ART

Buried (or even non-buried) pipes for transport of fluids, for example for transport of natural gas, can be repaired by application of composite bandages (‘composite wrap’) which enclose the damaged sections of the pipes. For example, corrosion can diminish the mechanical resistance of a metal pipe, and a composite wrap is to be applied, comprising for example glass or carbon fibre soaked in a resin, for example of epoxy type. It is evident that a composite wrap can be denoted by the expression composite reinforcement.

As is evident, it is of particular interest to be able to verify the ongoing effectiveness of repairs to those sections of metal pipe which have been reinforced structurally at the point of their damage. In fact, it can be interesting to monitor the evolution of the deformations of the pipe under the effect of stresses applied to it due for example to internal pressure, or even due for example to the temperature in the region of the sections which have been reinforced by the repair system.

Well known sensors from the prior art can be used to measure mechanical deformations and then provide information on the state of stress, such as resistive or piezoelectric gauges, or to measure the wall temperature of fibre Bragg gratings. If it is possible to tool a composite structure which constitutes the wrap with strain gauges, a specific limitation can prevent use of these gauges especially on buried pipes if the use of a wired communication system between the gauge and the interrogation system is not compatible with the environment of the pipe, especially but not exclusively the nature of the occupation of the surface zone. For example, an area of agricultural crops is a situation where it is not possible to allow a sensor connection device to emerge within 80 cm of the surface to take measurements without risking damage to this device.

For non-buried pipes, it can sometimes be difficult to install wired communication between the gauge, the sensor or sensors, and an interrogation system.

This solution is unsatisfactory and slows down instrumentation of structures.

The aim of the invention is to resolve at least some of the above drawbacks.

### EXPLANATION OF THE INVENTION

To this effect, the invention proposes a wireless measuring and communication device of information measured by means of an information measuring instrument relative to a buried pipe for example (the pipe is a buried pipe or not buried) and measured from the outside of this pipe, the device being configured for example so that it can be buried near the pipe (the device can be configured to be buried, or alternatively it may not be configured to be buried), the device comprising:
an interrogator, connected to the measuring instrument and configured to deliver the measured information,
a wireless communication module,
a control module of the interrogator and of the wireless communication module, configured to obtain the measured information (by the measuring instrument which can be external to the device) delivered via the interrogator and to send it for transmission to the wireless communication module (which is controlled for this transmission by the control module),
an electric power supply source powering the control module, the interrogator, and the wireless communication module.

It is therefore proposed to use a device which will communicate the measured information (typically a temperature or a deformation/mechanical stress) without the need to carry out excavation in the case of a buried pipe, since the device can be buried (it communicates wirelessly and houses an electric power supply source). Obtaining the information can be done simply by using an information receiver transmitted by the wireless communication module.

For a non-buried pipe but for which it is not possible to wire the measuring instrument to the device, the device could also be left in a non-accessible zone but have access to the data without entering the non-accessible zone.

In this case, an interrogator is a module which can interrogate a measuring instrument to obtain information measured by this measuring instrument.

In fact, the inventors have noticed that it is possible to use particular interrogators for a measuring instrument (for example an optic Bragg grating) having small dimensions for an application such as that of the present device, since they have limited electrical power consumption and can easily be integrated into the device. Also, measuring instruments of compact design are known, which can be integrated very closely to a pipe and especially into a pipe reinforcement without modifying their structural effectiveness (due to their compact design).

According to a particular embodiment, the device is configured to be buried (it can be in-ground) near the pipe which is a buried pipe.

In this way, this device is configured to be able to function (obtaining measured information, transmission to the wireless communication module, sending to the wireless communication module for transmission) when it is in the ground.

The device is therefore a device which operates autonomously, which has no wired connection other than the connection to the measuring instrument (typically a sensor).

For example, the device is protected by a case so that it can be buried.

According to a particular embodiment, the device also comprises an electrical relay configured to allow in its on position or prevent in its blocked position the powering of the control module, the interrogator, and the wireless communication module, based on a control signal.

For a buried device for which the access is difficile without excavation or for which access is impossible, it is necessary to limit the consumption of electrical power, in particular if the electric power supply source is a battery, so that the device can function for as long as possible. In this case it is proposed to use an electrical relay to authorise supply of the various elements of the device only when necessary. In fact, the different elements of the device preferably could be powered when an operator brings a receiver module to the surface plumb with the device (if it is buried) to receive the wireless transmission transmitted by the wireless communication module of the device, and the power supply to these elements could be cut off for the rest of the time.

In the present application, plumb means being at the position directly above the surface or in a region at the surface of at least a diameter less than 1 m centred on this position.

According to a particular embodiment, the control signal is generated by a clock module of the device equipped with a real-time clock, the clock module being configured to deliver a control signal placing the electrical relay in its on position over given time ranges, taking account of the real-time clock (the time ranges will be identified using real time), and to deliver a control signal placing the electrical relay in its blocked position outside the given time ranges.

In this way, it is proposed to make use of a clock module which can have limited electrical consumption to put the relay in its on position over given time ranges only. The real-time clock is generally designated by ‘RTC: Real Time Clock’.

By way of indication, the clock module can be supplied with electrical power by the electric power supply source or even by an additional electric power supply source.

According to a particular embodiment, the control signal is generated by an additional wireless communication module of the device, the additional wireless communication module being configured to deliver a control signal placing the electrical relay in its on position based on a signal received by the additional wireless communication module.

In this particular embodiment, an additional wireless communication module separate from the wireless communication module is used. Preferably, this additional wireless communication module has limited electrical power consumption, and is used only to receive a signal wireless to switch the electrical relay to its on state, for example for a limited time, or even until the device is switched off.

According to a particular embodiment, the additional wireless communication module is a radiofrequency module configured to be powered by a received wireless signal.

Radiofrequency modules, for example RFID (Radio-identification, or ‘Radio Frequency Identification’) generally comprise an antenna and a microcontroller, the microcontroller which can be supplied with electrical power by the radio signal received by the antenna (passive RFID tag). In this way, no consumption of electrical power is necessary, and sending, typically from the surface (when the device is buried), a wireless signal configured to the radiofrequency module could initiate generation of a signal to place the electrical relay into an on state. This particular embodiment is also advantageous relative to the one which utilises a real-time clock since these clocks can exhibit a time deviation which is emphasised over time, which can make them difficult to use.

This particular embodiment runs a wireless wake-up system, since the device, the elements of which cannot be powered, will be powered once the electrical relay has been switched on.

According to a particular embodiment, the wireless communication module is a software-defined radio module, configured to receive the information measured in digital form delivered by the control module, and to transmit it in the form of a radio signal.

The use of a software-defined radio module can easily adapt the sending frequency as a function of the application (depth in the ground if the device is buried, compatibility, etc). In fact, these modules promise particularly flexible use.

According to a particular embodiment, the device comprises watertight protective case receiving the interrogator, the wireless communication module, the control module, and the electric power supply source.

This case will preferably be made of polymer, to let wireless transmissions pass through. For example, a PVC or polypropylene case can be used to protect the device from the soil mass or its humidity if the device is buried.

By way of indication, the case is a case according to the protection index IP67 or IP68 (European standard EN 60529 in all its versions defining this index, for example in its 2013 version).

Also, this case can comprise a passage for connecting the measuring instrument to the interrogator via a connection, fitted with means for retaining the watertightness between the case and the connection (this can be a fibre optic, in particular if the measuring instrument is a fibre Bragg grating).

According to a particular embodiment, the electric power supply source is a battery.

Preferably, a deep-cycle battery could be selected.

The use of a battery is well adapted for devices which will become inaccessible, for example if they are buried.

The invention also proposes a system comprising a device such as defined hereinabove in all its embodiments, and a receiver module configured to receive the measured information transmitted by the wireless communication module.

The receiver module is preferably a module transportable by a user, which is brought for example to above the device to receive the measured information.

If an electrical relay with an additional wireless communication module is utilised, the receiver module can comprise a sub-module to send a signal which will be received by the additional wireless communication module to switch the electrical relay to the on state.

According to a particular embodiment, the receiver module is configured to execute said reception when it is arranged on the surface plumb with the device when the device is buried.

In this system, the device is configured so that it can be buried, for example if the pipe is buried.

The invention also proposes an installation comprising this system, a section of pipe, and an information-measuring instrument relative to the pipe and measured from the outside of this pipe, the measuring instrument being connected to the interrogator of the device of the system.

In particular, the section of pipe can comprise a composite wrap, a reinforcement, with the measuring instrument installed in this composite wrap.

In particular, if the measuring instrument is a fibre Bragg grating, this fibre encloses the pipe by being in the composite wrap.

According to a particular embodiment, the section of pipe is buried, the measuring instrument is buried (the measurement is taken in the sub-soil from the outside of the pipe), and the device is buried.

According to a particular embodiment, the measuring instrument is a fibre Bragg grating which encloses the pipe or a temperature sensor or a resistive strain gauge, or a piezoelectric strain gauge.

The invention also relates to a process for installation of a measuring and communication device such as defined hereinabove, wherein the device is installed in the vicinity of a pipe and an information-measuring instrument is installed relative to the pipe measured from the outside of this pipe, the measuring instrument being connected to the interrogator of the device of the system.

According to a particular embodiment, the pipe is buried, and positioning the device near the pipe comprises burying the device near the pipe, while positioning the measuring instrument comprises burying the measuring instrument outside the pipe.

The invention also proposes a process for using the device installed by the installation process defined hereinabove, in which a receiver module is positioned, and in which the receiver module receives the measured information transmitted by the wireless communication module.

According to a particular embodiment, the pipe is buried and the receiver module is positioned at the surface and plumb with the measuring device which is buried.

### BRIEF DESCRIPTION OF DRAWINGS

Other characteristics and advantages of the present invention will emerge from the following description in reference to the attached drawings which illustrate an embodiment devoid of any limiting character, in which:

FIG. 1 is a schematic representation of an installation according to an example.

FIG. 2 is a schematic representation of a device according to an example.

FIG. 3 is a diagram of the electrical relay.

FIG. 4 is a schematic representation of a clock module example.

FIG. 5 is a schematic representation of an additional wireless communication module.

FIG. 6 shows the steps taken for transmission.

FIG. 7 shows the steps taken for reception.

FIG. 8 is a graphic which illustrates the evolution of the signal-to-noise ratio as a function of a depth of soil.

FIG. 9 is a graphic which illustrates the evolution of the signal-to-noise ratio as a function of a depth of sand.

FIG. 10 a graphic which illustrates a measurement of deformations by a fibre Bragg grating.

### DESCRIPTION OF EMBODIMENTS

Measuring and communication devices designed to be buried in the soil and measure information obtained by a fibre Bragg grating which encloses a buried pipe will now be described. The invention is however not limited to fibre Bragg gratings and applies to other types of measuring instruments. In particular, a temperature sensor could be used, or a resistive strain gauge, or a piezoelectric strain gauge.

The invention is not limited however to buried devices and buried pipes.

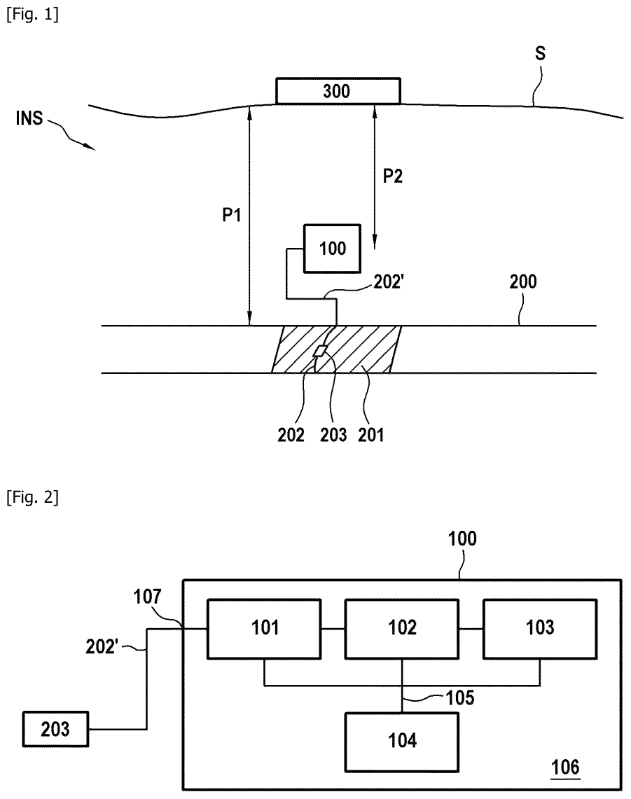

FIG. 1 is a schematic representation of an INS installation with a measuring and communication device 100 in a zone having a soil surface S, and, buried for example at a depth P1 of 1.5 m, a pipe 200 (or at the very least a section of pipe in a region).

As is known per se, the pipe, which is metal, for example made of steel, has been repaired by application of a composite wrap 201 (sometimes called reinforcement or ‘wrap’). The composite wrap comprises for example fibreglass or carbon fibre soaked in a resin of epoxy type.

When the composite wrap is being placed, a fibre optic 202 is installed around the pipe 200. This installation can be achieved by incorporating the fibre optic into the resin used to make the wrap or by a pause on the external surface of the wrap.

The fibre optic comprises a Bragg grating 203 and is therefore a fibre optic Bragg grating. The Bragg grating can be used for measuring deformations which can be converted into mechanical stresses or temperatures. It is evident that several Bragg gratings can be used, optionally on the same fibre (an interrogator capable of carrying out multiplexing of light can be utilised).

The fibre optic 202 comprises a section 202′ which is connected to the device 100 (this device will be described in more detail later in reference to FIG. 2), such that the device 100 recovers information which can be measured by means of the Bragg grating 203 (temperature, deformations, etc.). The device 100 communicates via wireless transmissions with the receiver module 300 placed at the surface plumb with the device 100.

As can be seen in the figure, the section of fibre 202′ helps space the device 100 away from the pipe 200. This allows the device 100 to be placed at a depth P2 measured at the surface which can be selected such that wireless communications between the device 100 and the surface are always carried out under the same conditions, at the same depth P2, with the same quantity of material of soil between the device and the surface (at least within a region where the soil is uniform). In fact, it has been observed that some frequencies are better adapted than others as a function of the density of the ground for transmission of information between a buried device and the surface. Since it is not possible to have a buried pipe which always extends to the same depth measured from the ground, it is preferable therefore to always place the devices at the same depth during installation.

FIG. 2 illustrates in more detail the device 100 of FIG. 1, connected by means of the fibre optic 202′ on the Bragg grating 203.

The fibre optic 202′ is more precisely connected to an interrogator for fibre Bragg grating which can deliver information measured by means of the Bragg grating 203, as is known per se, by emitting a light signal and by processing the reflected signal.

By way of indication, an interrogator having small dimensions could be used, such as the interrogator marketed under the name FGBT-200 by the American company REDONDO OPTICS INC. This interrogator has an integrated broadband light source (in the window centred on 1550 nm). This interrogator contains a port of two high-sensitivity reading channels for measuring deformation and/or temperature by means of Bragg grating sensor arrays. This interrogator is also adapted for use with several Bragg gratings and especially two gratings (one for measuring deformation, one for measuring temperature or deformation). The use of two Bragg gratings is advantageous since it compensates fluctuations with this interrogator. Finally, this interrogator is advantageous due to its low power consumption (power supply is via a USB connection, which is advantageous here).

In addition, this interrogator has small dimensions (width or length or height under ten centimetres).

The invention is nevertheless not limited to the use of this interrogator and can be implemented with other interrogators.

For example, an interrogator having at least some of the characteristics of the interrogator presented above could be used:
a broadband light source (preferably in the window centred on 1550 nm),
a port of two high-sensitivity reading channels for measuring deformation and/or temperature by means of Bragg grating sensor arrays,
be adapted for use with several Bragg gratings and especially two gratings (one for measuring deformation, one for measuring temperature or deformation),
low electrical power consumption (for example by USB).

The interrogator 101 delivers measured information to a control module 102. In fact, the control module 102 can have a computer structure, and, preferably, a structure of a unit called pico-computer. By way of indication, the pico-computer sold under the brand name LattePanda (according to all its versions) by the Chinese company of the same name could be used. This pico-computer can be equipped with a Windows 10 IoT operating system, especially for receiving the information measured by the interrogator 101.

The invention is however not limited to use of this pico-computer and can be operated with other pico-computers.

The device 100 also comprises a wireless communication module 103, which receives the measured information sent to it by the control module 102, for transmission. Preferably, the wireless communication module 103 is a software-defined radio module (‘SDR: Software-Defined Radio’ in English), configured to receive the measured information in digital form delivered by the control module 103, and to transmit it in the form of a radio signal.

For example, a software-defined radio module marketed under the name ‘HackRF One’ by the American company GREAT SCOTT GADGET could be used. This module is advantageous as it can be connected via USB to the pico-computer mentioned hereinabove. Also, even though it is used here as a transmitter, this module can also function as a receiver. It can also function at frequencies of between 1 MHz and 6 GHz. Other software-defined radio modules may be used.

Although not illustrated in the figure, an antenna will be used and this antenna can be integrated into the software-defined radio module or connected to this software-defined radio module.

Different antennae can be used. In particular a telescopic antenna such as the one marketed under the brand ‘SDR ANT500’ by the American company GREAT SCOTT GADGET could be used. An antenna on a printed circuit board could also be used, and especially an antenna of the ‘MDF’ range marketed by the German company AARONIA AG.

By way of indication, it is evident that the antenna ‘SDR ANT500’ and an ‘MDF’ antenna respectively can be adapted for different applications. The inventors of the present invention have noted that for a frequency of 169 MHz, the antenna ‘SDR ANT500’ produces a better signal-to-noise ratio than an ‘MDF’ antenna for densities of sand between the device and the surface of between 86 cm and 45 cm, then between 0 and 5 cm, the ‘MDF’ antenna having a better signal-to-noise ratio between 5 and 45 cm. It is clear that the choice of antenna will depend on the application and more precisely on the soil and depth.

The emission frequency is also a parameter to consider for selecting the antenna. Different frequencies have been tested by the inventors of the present invention, for different densities of earth or sand (in a test vat). By way of indication, a frequency of 169 MHz can be adapted.

Of course, regulatory stresses can also considered for selecting the emission frequency. In particular, ISM frequency bands (Industrial, Scientific, Medical) well known to the skilled person could be used.

The device 100 further comprises an electric power supply source 104, which supplies the control module 102, the interrogator 101, and the wireless communication module 103. The power supply is delivered by way of connections 105.

Preferably, the electric power supply source 104 is a deep-cycle battery. For example, the deep-cycle battery marketed under the brand name ‘AGM VARTA LAD 24’ by the German company Varta AG could be used. By way of indication, if the device 100 is used for measuring information and transmitting it every quarter (use can take 15 minutes per quarter), the device can have a lifespan of the order of 30 years.

To protect the device 100 from the mass of the soil and humidity, a case 106 is used, preferably made of polymer, for wireless transmissions to pass through. For example, the case 106 can be a case made of PVC or polypropylene, and this case is watertight.

The case however includes an opening 107 for passage of the fibre optic 202′ which can be fitted with means for maintaining watertightness (for example a joint). It is obvious that if measuring instruments other than fibre optics are used, the case can include an opening for wired connection to these other measuring instruments.

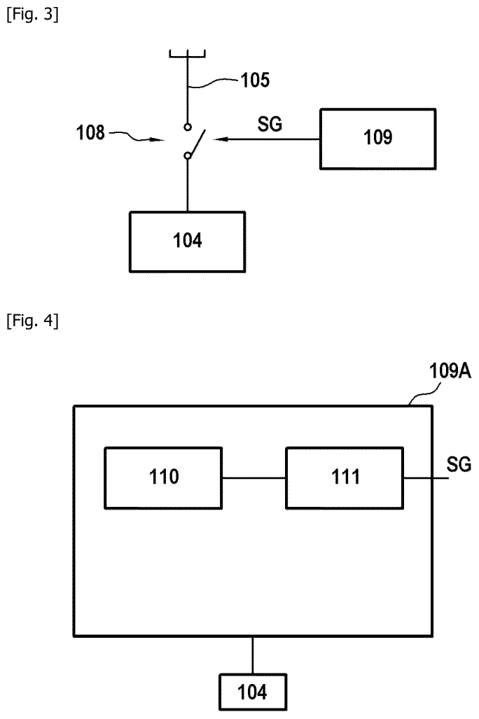

FIG. 3 illustrates an exemplary embodiment of the section dedicated to the electric power supply in the device 100 in which an electrical relay 108 is used.

The electrical relay 108 is connected in series between the battery 104 on the one hand, and the control module 102, the interrogator 101, and the wireless communication module 103 on the other hand. It is controlled by an SG signal developed by a unit 109 to allow in its on position or prevent in its blocked position the power supply of the control module, the interrogator, and the wireless communication module.

The unit 109 preferably develops the SG signal to limit electrical power consumption of the device, and especially so that the device consumes power only when an operator has brought a receiver module to the surface plumb with the device. In other words, the signal S controls the electrical relay so that it in is an on state only during selected time frames.

FIG. 4 shows a first example of unit 109A capable of developing the signal SG described in reference to FIG. 3. The unit 109A is here a clock module.

The clock module 109A is equipped with a real-time clock 110 (RTC), and a controller 111 (for example a microcontroller). For example, the controller 111 will deliver a signal SG to place the electrical relay in its on position over given time ranges. These ranges can be regular (for example one range per month), or even be defined for fixed dates and times.

The clock module doit however be powered, for example by the battery 104.

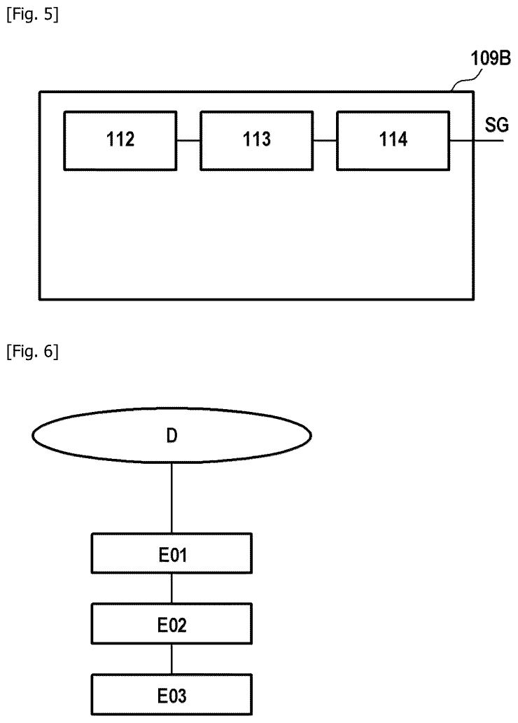

FIG. 5 shows a second example of unit 109B capable of developing the signal SG described in reference to FIG. 3. In this case the unit 109B is an additional wireless communication module, and more precisely an RFID module.

The RFID module is configured to be powered by a signal received, and it comprises an antenna 112, an amplifier stage 113 (by way of example, a cascade of condensers can be used), and a microcontroller 114 configured, when it is powered by the signal received, to develop a signal SG which switches the electrical relay to its on state, for example for a predefined time.

FIG. 6 shows the steps performed in the software-defined radio module 103 described in reference to FIG. 2 during transmission of data D transmitted by the control module 102. By way of indication, when the elements of the device 100 are powered, a computer program can be run on the control module 102 to control the interrogator, and obtain several measured items of information which will be recorded in a memory of the control module 102 (for example, the measured information can comprise several measurements spaced over time and optionally of different types (temperatures, deformations/stresses)). The information measured is the data D to be transmitted here.

The data D transmitted by the control module 102 are first encoded (step E01) in packets for a given communication protocol (typically a protocol compatible with the receiver module which will be used).

Next, step E02 carries out modulation prior to transmission, for example Gaussian minimum-shift keying (‘GMSK: Gaussian Minimum-Shift Keying’ in English). Other types of modulation can be used.

The modulated signal is then transmitted to the antenna for its emission at step E03.

The emission can be carried out repeatedly over a given time, after which the device 100 can be switched off (this can also correspond to switching to the blocked state of the electrical relay).

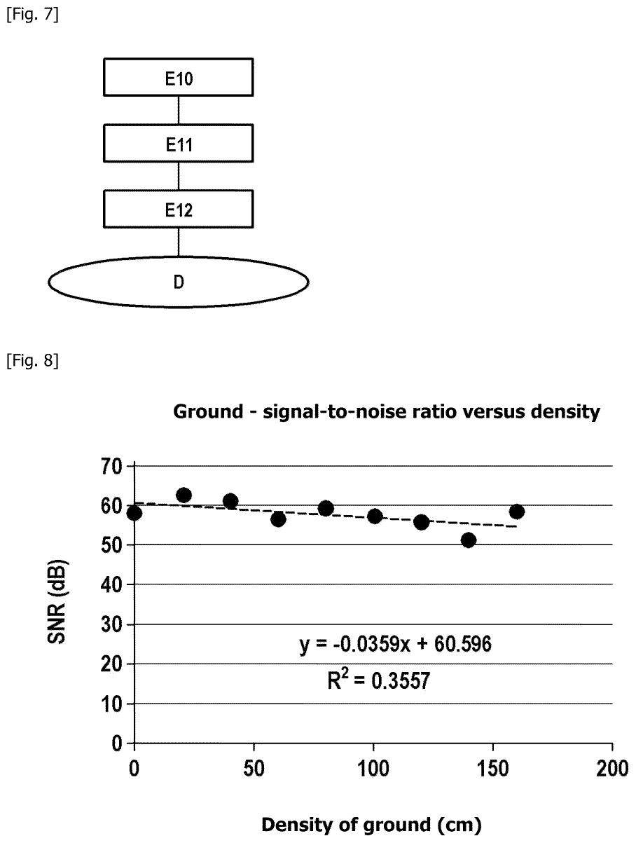

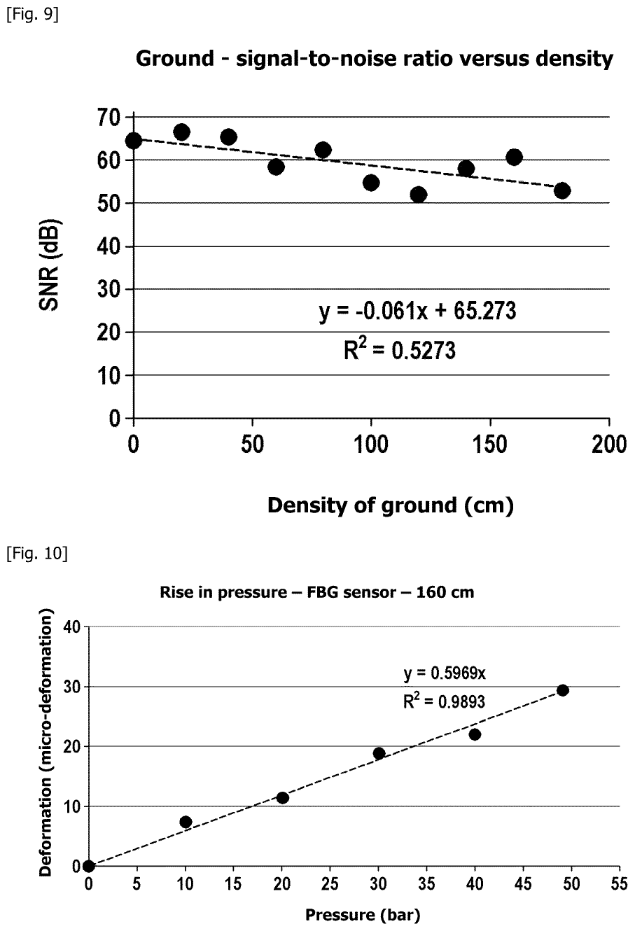

FIG. 7 illustrates the steps taken within a receiver module 300, used when the device has transmitted the measured information.

It is first evident that the receiver module is selected to be compatible with the software-defined radio module 103 described hereinabove. By way of indication, the receiver marketed under the brand ‘Airspy mini’ by the French company AIRSPY could be used; it is less expensive than an emitter such as the one mentioned hereinabove for the software-defined radio module 103.

Once the receiver module 300 is placed on the surface plumb with the device 100, and once the device 100 has performed steps E01 to E03 described in reference to FIG. 6, step E10 for demodulation of the signal received by an antenna of the receiver module 300 can be taken (typically Gaussian minimum-shift keying), decoding of packets (step E11), and recording of data D in step E12.

FIG. 8 shows the evolution of the signal-to-noise ratio (in decibels), relative to ground density (in centimetres). These measurements have been taken in a vat.

As is evident, the signal-to-noise ratio decreases with depth but still stays above 50 dB, which means that the signal can be well received.

In different soil, containing sand only, there is also a decrease, but always a signal-to-noise ratio above 50 dB.

Of course, these results are obtained plumb with the device.

FIG. 10 illustrates the result of a pressure test, done by filling a tank with water and using a fibre Bragg grating, with the interrogator described hereinabove, to illustrate its capacity to deliver deformation values. There is an increase in deformations (in this case microdeformations, without unit) with a rise in pressure in bars.

The above describes a measuring and communication device for information measured by means of a fibre Bragg grating, a device which can be buried near a pipe which itself is buried, to be connected to a fibre Bragg grating which encloses the pipe (especially in a composite wrap).

The transmission frequencies could be adapted especially as a function of the application and of the selected depth.

Information on the state of a pipe or its composite wrap can be obtained in this way without carrying out any excavation and without need to unearth connections to the buried device at under 1 m from the surface.

1.-17. (canceled)

18. A wireless measuring and communication device of information measured by means of a measuring instrument of information relative to a pipe buried and measured from the outside of this pipe, the device being configured so that it can be buried near the pipe, the device comprising:
an interrogator connected to the measuring instrument and configured to deliver the measured information,
a wireless communication module,
a control module of the interrogator and of the wireless communication module, configured to obtain the measured information delivered by the interrogator and to send it to the wireless communication module for transmission,
an electric power supply source powering the control module, the interrogator, and the wireless communication module,
also comprising an electrical relay configured in its on position to allow or prevent in its blocked position the powering of the control module, of the interrogator, and of the wireless communication module, based on a control signal.

19. The device according to claim 18, wherein the device is configured to be buried near the pipe which is a buried pipe.

20. The device according to claim 18, wherein the control signal is generated by a clock module of the device equipped with a real-time clock, the clock module being configured to deliver a control signal placing the electrical relay in its on position over given time ranges, taking account of the real-time clock, and to deliver a control signal placing the electrical relay in its blocked position outside the given time ranges.

21. The device according to claim 18, wherein the control signal is generated by an additional wireless communication module of the device, the additional wireless communication module being configured to deliver a control signal placing the electrical relay in its on position based on a signal received by the additional wireless communication module.

22. The device according to claim 21, wherein the additional wireless communication module is a radiofrequency module configured to be powered by a received wireless signal.

23. The device according to claim 18, wherein the wireless communication module is a software-defined radio module, configured to receive the information measured in digital form delivered by the control module, and to transmit it in the form of a radio signal.

24. The device according to claim 18, comprising a watertight protective case receiving the interrogator, the wireless communication module, the control module, and the electric power supply source.

25. The device according to claim 18, wherein the electric power supply source is a battery.

26. A system comprising a device according to claim 18, and a receiver module configured to receive the information measured transmitted by the wireless communication module.

27. The system according to claim 26, wherein the receiver module is configured to implement said reception when it is arranged on the surface plumb with the device when the device is buried near the pipe which is a buried pipe.

28. An installation comprising a system according to claim 26, a section of pipe, and an information-measuring instrument relative to the pipe and measured from the outside of this pipe, the measuring instrument being connected to the interrogator of the device of the system.

29. The installation according to claim 28, in which the section of pipe is buried, the measuring instrument is buried, and the device is buried.

30. The installation according to claim 28, in which the measuring instrument is a fibre Bragg grating which encloses the pipe or a temperature sensor or a resistive strain gauge, or a piezoelectric strain gauge.

31. A process for installation of a measuring and communication device according to claim 18, wherein the device is installed in the vicinity of a pipe and an information measuring instrument is installed relative to the pipe measured from the outside of this pipe, the measuring instrument being connected to the interrogator of the device.

32. The process according to claim 31, wherein the pipe is buried, and positioning the device near the pipe comprises burying the device near the pipe, and positioning the measuring instrument comprises burying the measuring instrument outside the pipe.

33. A process for using the device installed by the process according to claim 31, wherein a receiver module is positioned, and wherein the receiver module receives the information measured transmitted by the wireless communication module.

34. The process according to claim 33, wherein the pipe is buried and the receiver module is positioned on the surface and plumb with the measuring device which is buried.
